(19) United States
(12) Patent Application Publication
(10) Pub. No.: US 2017/0353846 A1
(43) Pub. Date: Dec. 7, 2017

(54) EMERGENCY NOTIFICATION SYSTEM, EMERGENCY NOTIFICATION DEVICE, CENTER DEVICE, PORTABLE TERMINAL DEVICE, EMERGENCY NOTIFCATION PROGRAM PRODUCT

(71) Applicant: DENSO CORPORATION, Kariya-city, Aichi-pref. (JP)

(72) Inventor: Hiroki OGAWA, Kariya-city (JP)

(21) Appl. No.: 15/535,421

(22) PCT Filed: Dec. 15, 2015
(86) PCT No.: PCT/JP2015/006256

§ 371 Date: Jun. 13, 2017

(30) Foreign Application Priority Data
Dec. 22, 2014 (JP) 2014-258692

(51) Int. Cl. H04W 4/22

(52) U.S. Cl. CPC H04W 4/22

(57) ABSTRACT

An emergency notification system includes an emergency notification device equipped to a vehicle, a center device disposed at a service center and making a call with the emergency notification device through a wireless communication line, and a portable terminal device communicably connected with the emergency notification device in a wireless manner. The emergency notification device is configured to output a call reception signal to the portable terminal device when a predetermined condition is satisfied, acquire a phone number from the portable terminal device that received the call reception signal, and transmit, to the center device, the acquired phone number. The center device includes a phone number setting unit that sets the received phone number as a new destination phone number instead of a phone number of the emergency notification device which is preliminarily set as a destination phone number.

### CROSS REFERENCE TO RELATED APPLICATION

This application is based on Japanese Patent Application No. 2014-258692 filed on Dec. 22, 2014, the disclosure of which is incorporated herein by reference.

### TECHNICAL FIELD

The present disclosure relates to an emergency notification system that performs an emergency notification in the event of the emergency of a vehicle, an emergency notification device that constitutes the emergency notification system, a center device, a portable terminal device, and an emergency notification program product installed and executed in each of the emergency notification device, the center device, and the portable terminal device.

### BACKGROUND ART

For example, Patent Literature 1 has proposed a system that notifies a center of a vehicle position in the event of the emergency of a vehicle to promptly dispatch an emergency vehicle. In recent years, the following systems have also been proposed. In this system, a phone number is assigned to an emergency notification device mounted on a vehicle, and the phone number is registered in advance in the center as a destination phone number. When receiving an emergency notification signal from the emergency notification device in the event of the vehicle emergency, a center operator calls the destination phone number corresponding to the emergency notification device. As a result, an occupant of the vehicle can directly inform the operator of a situation, and the operator can promptly perform handling such as the dispatching of the emergency vehicle according to the determined situation.

### PRIOR ART LITERATURE

### Patent Literature

[Patent Literature 1] JP 3073960 B2

### SUMMARY OF INVENTION

In the conventional system described above, the occupant of the vehicle cannot transmit or receive a call with the operator unless the emergency notification device is used. For that reason, in a situation where the occupant of the vehicle needs to depart from the vehicle, it may be difficult to transmit or receive a call using the emergency notification device.

In consideration of the above difficulties, it is an object of the present disclosure to provide an emergency notification system which enables a call with an operator even when it is difficult to use an emergency notification device in the event of the emergency situation of the vehicle. It is also an object of the present disclosure to provide an emergency notification device that constitutes the emergency notification system, a center device, a portable terminal device, and an emergency notification program product that is incorporated and executed in each of the emergency notification device, the center device, and the portable terminal device.

According to a first aspect of the present disclosure, an emergency notification system includes an emergency notification device equipped to a vehicle, a center device disposed at a service center and making a call with the emergency notification device through a wireless communication line, and a portable terminal device communicably connected with the emergency notification device in a wireless manner. The emergency notification device includes a call reception signal output unit outputting a call reception signal to the portable terminal device when a predetermined condition is satisfied, a phone number acquisition unit acquiring a phone number of the portable terminal device from the portable terminal device that received the call reception signal, and a phone number transmission unit transmitting, to the center device, the phone number that is acquired. The center device includes a phone number setting unit that sets the phone number transmitted from the emergency notification device as a new destination phone number instead of a phone number of the emergency notification device which is preliminarily set as a destination phone number.

With the above emergency notification system, when the vehicle is in an emergency situation and transmitting or receiving of a phone call with use of the emergency notification device is difficult, the destination phone number preliminarily registered in the center device is switched from the phone number of the emergency notification device to the phone number of the portable terminal device. Thus, the user can use the portable terminal device to transmit or receive a call with an operator on a side of the center device.

According to a second aspect of the present disclosure, an emergency notification device includes a call reception signal output unit, a phone number acquisition unit, and a phone number transmission unit. The emergency notification device is equipped to a vehicle, and constitutes an emergency notification system together with a center device and a portable terminal device. The center device is disposed at a service center and makes a call with the emergency notification device through a wireless communication line. The portable terminal device is communicably connected with the emergency notification device in a wireless manner. In the emergency notification device, the call reception signal output unit outputs a call reception signal to the portable terminal device when a predetermined condition is satisfied, the phone number acquisition unit acquires a phone number of the portable terminal device from the portable terminal device that received the call reception signal, and the phone number transmission unit transmits, to the center device, the phone number that is acquired.

With the above emergency notification device, advantages similar to the advantages provided by the emergency notification system according to the first aspect can be provided.

According to a third aspect of the present disclosure, a center device includes a phone number setting unit. The center device is disposed at a service center and makes a call with an emergency notification device equipped to a vehicle through a wireless communication line. The center device constitutes an emergency notification system together with the emergency notification device and a portable terminal device. The portable terminal device is communicably connected to the emergency notification device in a wireless manner. In the center device, the phone number setting unit sets a phone number received from the emergency notification device as a new destination phone number instead of a phone number of the emergency notification device which is preliminarily set as a destination phone number.

With the above center device, advantages similar to the advantages provided by the emergency notification system according to the first aspect can be provided.

According to a fourth aspect of the present disclosure, a portable terminal device includes a phone number notification unit. The portable terminal device is communicably connected to an emergency notification device equipped to a vehicle in a wireless manner. The portable terminal device constitutes an emergency notification system together with the emergency notification device and a center device. The center device is disposed at a service center and makes a call with the emergency notification device through a wireless communication line. In the portable terminal device, the phone number notification unit notifies the emergency notification device of a phone number of the portable terminal device upon receiving a call reception signal from the emergency notification device.

With the above portable terminal device, advantages similar to the advantages provided by the emergency notification system according to the first aspect can be provided.

According to a fifth aspect of the present disclosure, an emergency notification program product installed in and executed by an emergency notification device is provided. The emergency notification device constitutes an emergency notification system. The emergency notification system includes the emergency notification device equipped to a vehicle, a center device disposed at a service center and making a call with the emergency notification device through a wireless communication line, and a portable terminal device communicably connected with the emergency notification device in a wireless manner. The emergency notification program product is stored in a non-transitory tangible computer readable storage medium and comprises instructions executable by a computer. The instructions are for implementing a call reception signal output process that outputs a call reception signal to the portable terminal device when a predetermined condition is established, a phone number acquisition process that acquires a phone number of the portable terminal device from the portable terminal device that received the call reception signal, and a phone number transmission process that transmits, to the center device, the phone number that is acquired.

With the above emergency notification program product, when the vehicle is in an emergency situation and transmitting or receiving of a phone call with use of the emergency notification device is difficult, the destination phone number preliminarily registered in the center device is switched from the phone number of the emergency notification device to the phone number of the portable terminal device. Thus, the user can use the portable terminal device to transmit or receive a call with an operator on a side of the center device.

According to a sixth aspect of the present disclosure, an emergency notification program product installed in and executed by a center device is provided. The center device constitutes an emergency notification system. The emergency notification system includes an emergency notification device equipped to a vehicle, the center device disposed at a service center and making a call with the emergency notification device through a wireless communication line, and a portable terminal device communicably connected with the emergency notification device in a wireless manner. The emergency notification program product is stored in a non-transitory tangible computer readable storage medium and comprises instructions executable by a computer, the instructions are for implementing a phone number setting process that sets a phone number newly transmitted from the emergency notification device as a new destination phone number instead of a phone number of the emergency notification device which is preliminarily set as a destination phone number.

With the above emergency notification program product, advantages similar to the advantages provided by the emergency notification program product according to the fifth aspect can be provided.

According to a seventh aspect of the present disclosure, an emergency notification program product installed in and executed by a portable terminal device is provided. The portable terminal device constitutes an emergency notification system. The emergency notification system includes an emergency notification device equipped to a vehicle, a center device disposed at a service center and making a call with the emergency notification device through a wireless communication line, and the portable terminal device communicably connected with the emergency notification device in a wireless manner. The emergency notification program product is stored in a non-transitory tangible computer readable storage medium and comprises instructions executable by a computer, and the instructions are for implementing a phone number notification process that notifies the emergency notification device of a phone number of the portable terminal device upon receiving a call reception signal from the emergency notification device.

With the above emergency notification program product, advantages similar to the advantages provided by the emergency notification program product according to the fifth aspect can be provided.

### BRIEF DESCRIPTION OF DRAWINGS

The above and other objects, features and advantages of the present invention will become more apparent from the following detailed description made with reference to the accompanying drawings. In the drawings:

FIG. 1 is a diagram schematically illustrating a configuration example of an emergency notification system according to a first embodiment of the present disclosure;

FIG. 2 is a diagram illustrating an example of an authentication window according to the first embodiment;

FIG. 3 is a diagram schematically illustrating an example of an emergency notification operation according to the first embodiment;

FIG. 4 is a diagram schematically illustrating a configuration example of an emergency notification system according to a second embodiment of the present disclosure;

FIG. 5 is a diagram schematically illustrating an example of emergency notification operation according to the second embodiment; and

FIG. 6 is a diagram illustrating an example of a call reception window according to the second embodiment.

### EMBODIMENTS FOR CARRYING OUT INVENTION

Hereinafter, embodiments of the present disclosure will be described with reference to the drawings. Hereinafter, in the respective embodiments, substantially the same elements are denoted by identical symbols, and repetitive description will be omitted.

### First Embodiment

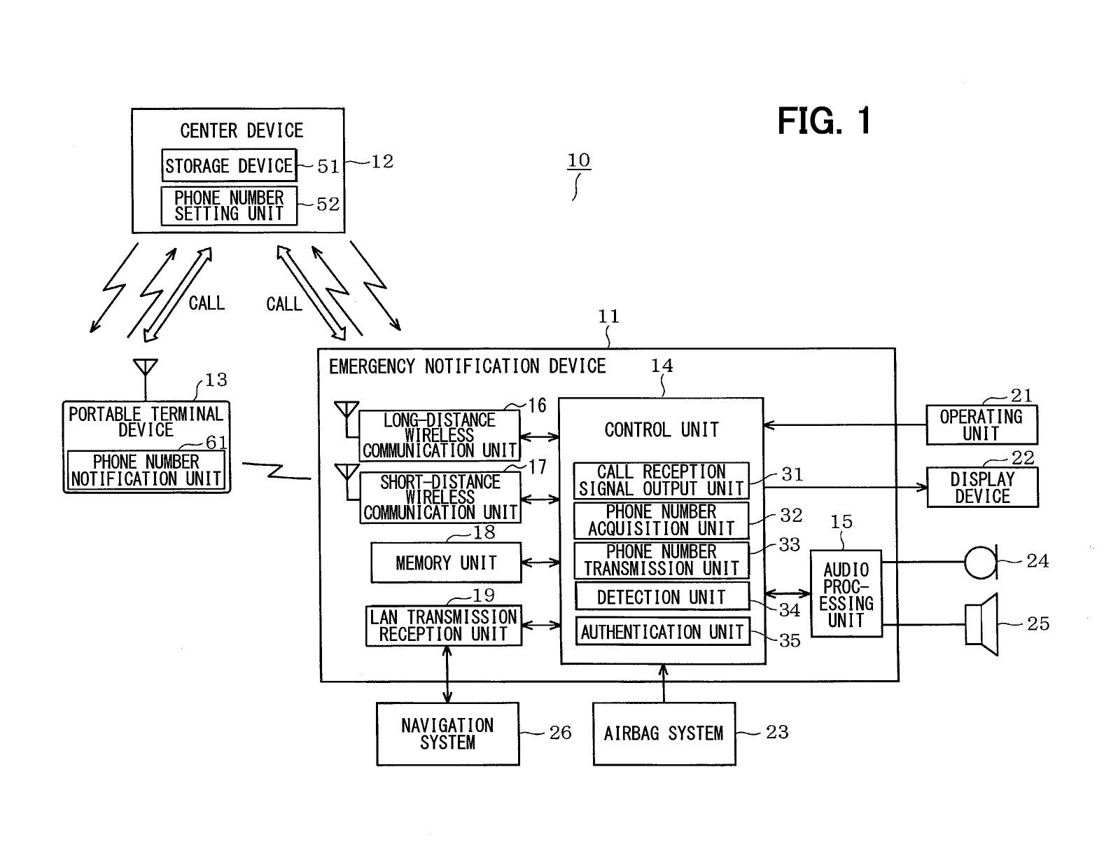

An emergency notification system 10 illustrated in FIG. 1 includes an emergency notification device 11 equipped to a vehicle, a center device 12 disposed in a service center, and a portable terminal device 13 carried by, for example, an occupant of a vehicle. The center device 12 is capable of, through a wide area wireless communication network, making a call and performing a data communication with the emergency notification device 11 and the portable terminal device 13.

The emergency notification device 11 includes a control unit 14, a audio processing unit 15, a long-distance wireless communication unit 16, a short-distance wireless communication unit 17, a memory unit 18, a LAN transmission and reception unit 19, and the like. The control unit 14 of the emergency notification device 11 is connected with an operating unit 21, a display device 22, and an airbag system 23. The audio processing unit 15 of the emergency notification device 11 is connected with a microphone 24 and a speaker 25. The LAN transmission and reception unit 19 of the emergency notification device 11 is connected with a navigation system 26 which performs route guidance for the vehicle.

The control unit 14 is mainly configured by a microcomputer having a CPU, and controls the overall operation of the emergency notification device 11. Further, the control unit 14 executes an emergency notification program using the CPU, to virtually provide various processing units such as a call reception signal output unit 31, a phone number acquisition unit 32, a phone number transmission unit 33, a detection unit 34, and an authentication unit 35 by executing a software program. Alternatively, these processing units may also be configured by a hardware circuit in the emergency notification device 11.

The audio processing unit 15 is configured by a well-known audio processing circuit, digitally processes an audio signal input from the microphone 24, and outputs the processed audio signal to the control unit 14. Further, the audio processing unit 15 converts a digital signal input from the control unit 14 into an audio signal and outputs the converted audio signal from the speaker 25. Since the emergency notification device 11 is equipped with the audio processing unit 15, the emergency notification device 11 can function as a so-called phone.

The long-distance wireless communication unit 16 is a circuit which connects a wireless communication line through a wide area wireless communication network in response to a connection command signal, or disconnects the wireless communication line in response to a disconnection command signal. Herein, the wide area communication network is a communication infrastructure, and the connection command signal and the disconnection command signal are output from the control unit 14. In other words, the long-distance wireless communication unit 16 connects or disconnects the wireless communication line provided between the emergency notification device and the center device 12 located in a remote place.

The short-distance wireless communication unit 17 is a circuit for establishing a wireless communication line based on a Bluetooth communication standard (Bluetooth: registered trademark). Herein, Bluetooth is an example of the short-distance wireless communication standard. When the portable terminal device 13 having the Bluetooth communication function is brought into a vehicle compartment, the short-distance wireless communication unit 17 automatically establishes the wireless communication line under Bluetooth standard with the portable terminal device 13. The wireless communication line established by the short-distance wireless communication unit 17 is automatically disconnected when a distance between the emergency notification device 11 and the portable terminal device 13 is equal to or greater than a predetermined distance.

The memory unit 18 is configured by a storage device including a nonvolatile memory or the like, and stores various kinds of information such as a device ID for specifying the vehicle, in other words, the emergency notification device 11. Authentication information for authenticating the portable terminal device 13 is stored in the memory unit 18, in advance. The authentication information includes information which associates identification information for identifying the portable terminal device 13 carried by the user with password information set by the user. The user may preliminarily register the authentication information in the emergency notification device 11 through a user registration process in advance.

The LAN transmission and reception unit 19 has an interface function with the in-vehicle LAN. In this case, the LAN transmission and reception unit 19 transmits and receives various kinds of information to and from the navigation system 26. The navigation system 26 provides, to the control unit 14, current position information indicative of a current position of the vehicle, speed information indicative of a speed of the vehicle, distance information indicative of a distance from the current position to a destination, and the like through the LAN transmission and reception unit 19. The control unit 14 generates an emergency notification signal including information obtained from the navigation system 26, information stored in the memory unit 18, and the like. The control unit 14 transmits the generated emergency notification signal to the center device 12 through the long-distance wireless communication unit 16.

When an airbag (not shown) is deployed, the airbag system 23 generates an airbag deployment signal. Then, the airbag system 23 outputs a generated airbag deployment signal to the control unit 14 as a collision detection signal. The control unit 14 generates and outputs the above-described emergency notification signal with the collision detection signal output from the airbag system 23 as a trigger. The operating unit 21 includes an emergency notification button operable by the user. When the emergency notification button is operated, the operating unit 21 outputs an operation signal to the control unit 14. The display device 22 is configured by, for example, a liquid crystal display, an organic EL display, or the like. The display device 22 displays various kinds of information based on a display command signal output from the control unit 14.

The call reception signal output unit 31 is an example of call reception signal output means, and outputs a call reception signal to the portable terminal device 13 when a predetermined condition is satisfied. In this case, when the user has moved to the outside of the vehicle, the predetermined condition is determined to be satisfied. In other words, the call reception signal output unit 31 is configured to output a call reception signal when it is detected that the user has moved to the outside of the vehicle. The phone number acquisition unit 32 is an example of phone number acquisition means, and acquires the phone number assigned to the portable terminal device 13 from the portable terminal device 13 that has received the call reception signal. The phone number transmission unit 33 is an example of phone number transmitting means, and transmits the acquired phone number of the portable terminal device 13 to the center device 12.

The detection unit 34 is an example of detection means, and detects whether the user of the portable terminal device 13 has moved outside of the vehicle. The detection unit 34 detects that the user has moved outside of the vehicle when a well-known seating sensor (not shown) for detecting that an occupant is seated on a seat of the vehicle switches from on state to off state. It should be noted that a configuration for implementing the detection function by the detection unit 34 is not limited to the configuration using the seating sensor. For example, the detection unit 34 may be configured to detect that the user has moved out of the vehicle based on a detection of the opening and closing of a door by a well-known door opening and closing sensor which is not shown. The door opening and closing sensor detects the opening or closing of the door of the vehicle.

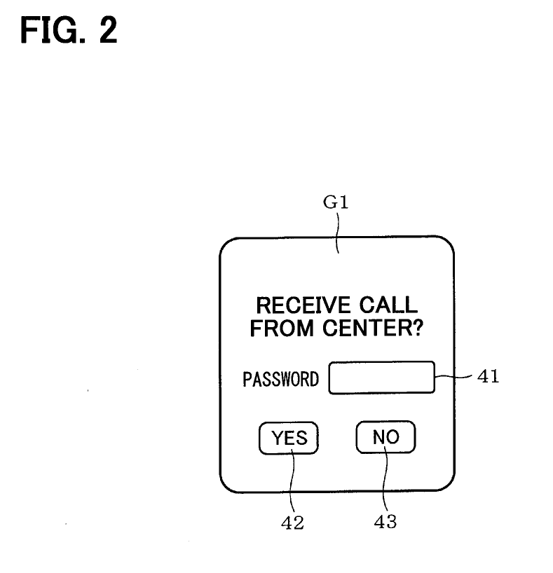

The authentication unit 35 is an example of authenticating means, and executes authentication process for authenticating the portable terminal device 13 when the detection unit 34 detects that the user has moved outside of the vehicle. In this authentication process, the authentication unit 35 specifies the portable terminal device 13 carried by the user based on the authentication information stored in the memory unit 18. Then, the authentication unit 35 transmits authentication window data to the specified portable terminal device 13, and displays an authentication window G1 shown in FIG. 2 on a display unit of the portable terminal device 13.

The authentication window G1 includes a password input unit 41 for inputting a password as the user authentication information, a YES button 42 for permitting the reception of a call, and a NO button 43 for forbidding reception of the call. When the user inputs the password into the password input unit 41 and operates the YES button 42, the portable terminal device 13 transmits the user authentication information including the input password information to the emergency notification device 11. The authentication unit 35 compares the password information obtained from the portable terminal device 13 with the password information preliminarily stored in the memory unit 18. Then, when the two password information matches each other, the authentication unit 35 determines that authentication is valid, and when the two password information does not match each other, the authentication unit 35 determines that authentication is invalid.

The center device 12 is provided by a computer for emergency response which is operated by the operator working in the service center, and includes a storage device 51. A device ID for specifying the emergency notification device 11, a user ID for specifying the user, and the destination phone number are stored in the storage device 51 in advance in association with each other. As the destination phone number, initially, the phone number assigned to the emergency notification device 11 is stored. For that reason, an operator who operates the center device 12 can make a call to the user on a side of the emergency notification device 11 using the preliminarily registered destination phone number.

A not-shown control unit for controlling the overall operation of the center device 12 virtually implements a phone number setting unit 52 in a software manner by executing an emergency notification program using a CPU. In the center device 12, the phone number setting unit 52 may be configured by a hardware circuit. The phone number setting unit 52 is an example of phone number setting means. When receiving a new phone number from the emergency notification device 11, the phone number setting unit 52 sets the received phone number as a new destination phone number instead of the phone number of the emergency notification device 11 preliminarily set in the storage device 51 as the destination phone number. In other words, the phone number setting unit 52 switches the phone number registered as the destination phone number from the phone number of the emergency notification device 11 to the phone number of the portable terminal device 13.

A not-shown control unit for controlling the overall operation of the portable terminal device 13 virtually implements a phone number notification unit 61 in a software manner by executing an emergency notification program using a CPU. In the portable terminal device 13, the phone number notification unit 61 may be configured by a hardware circuit. The phone number notification unit 61 is an example of a phone number notification means, and upon receiving a call reception signal from the emergency notification device 11, the phone number notification unit 61 notifies the emergency notification device 11 of the phone number assigned to the portable terminal device 13.

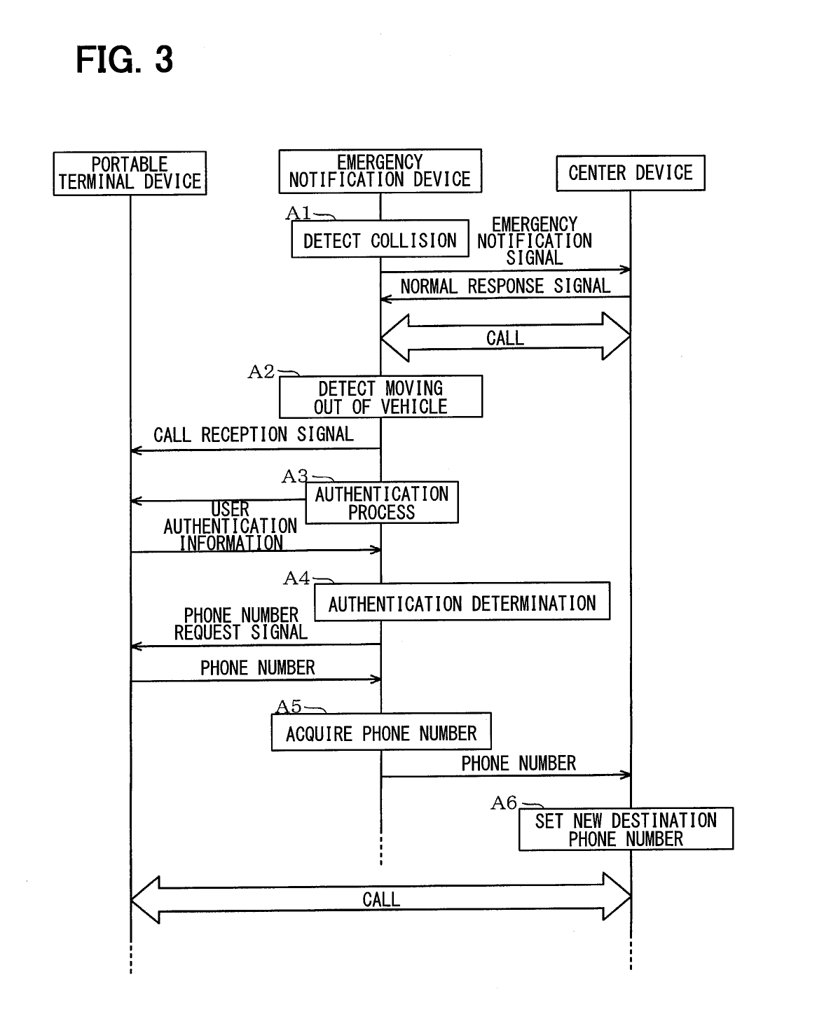

Next, an example of the emergency notification operation executed by the emergency notification system 10 will be described. As illustrated in FIG. 3, when a collision detection signal is outputted from the airbag system 23 in response to a deployment of the airbag (A1), the emergency notification device 11 outputs an emergency notification signal to the center device 12. Upon receiving the emergency notification signal, the center device 12 specifies the emergency notification device 11 that has transmitted the emergency notification signal, based on the information included in the emergency notification signal. Then, the center device 12 transmits a normal response signal to the specified emergency notification device 11. The normal response signal is a signal indicating that the emergency notification signal has been normally received.

In addition, the center device 12 searches the information group stored in the storage device 51 for the destination phone number stored in correspondence with the specified emergency notification device 11. Then, the center device 12 automatically makes a call to the searched destination phone number, and establishes a state in which a calling communication is enabled between the specified emergency notification device 11 and the center device 12. Alternatively, the center device 12 may display the retrieved destination phone number on a display unit such as a display instrument, and an operator working in the service center may make a phone call to the emergency notification device 11.

With the establishment of a communication line between the emergency notification device 11 and the center device 12 as described above, the user on the side of the emergency notification device 11 and the operator on the side of the center device 12 can communicate with each other. Therefore, the user can directly inform the operator of the emergency situation, and the operator can take proper actions such as dispatching an emergency vehicle, for example, in accordance with the situation notified by the user.

In an emergency situation of the vehicle, there is a case where the user has to leave the vehicle. In such a case, the user is unable or difficult to transmit or receive a call to or from the operator through the emergency notification device 11 equipped to the vehicle. According to the emergency notification system 10 of the present embodiment, even if the user has to leave the vehicle, the user can properly communicate with the operator.

The emergency notification device 11 monitors whether the user has moved outside of the vehicle or not. When detecting that the user has moved outside of the vehicle (A2), the emergency notification device 11 outputs a call reception signal to the portable terminal device 13 registered in the memory unit 18. In addition, the emergency notification device 11 executes authentication process on the portable terminal device 13 (A3). Then, the emergency notification device 11 performs an authentication determination based on the user authentication information obtained from the portable terminal device 13. In this example, the password information is used as the user authentication information (A4).

When determining that the authentication of the portable terminal device 13 is valid, the emergency notification device 11 outputs a phone number request signal to the portable terminal device 13. Upon receiving the phone number request signal, the portable terminal device 13 notifies the emergency notification device 11 of the phone number assigned to the portable terminal device 13. As a result, the emergency notification device 11 receives the call reception signal and acquires the phone number of the portable terminal device 13 from the portable terminal device 13 which is authenticated to be valid (A5). Then, the emergency notification device 11 transmits the acquired phone number to the center device 12.

Upon receiving the phone number from the emergency notification device 11, the center device 12 replaces the phone number of the emergency notification device 11 previously set as the destination phone number with the received phone number as a new destination phone number (A6). Then, the center device 12 automatically makes a call to the newly set destination phone number, and establishes a state in which a calling communication is enabled between the portable terminal device 13 and the center device 12. Alternatively, the center device 12 may display a newly set destination phone number on a display unit such as a display instrument, and an operator working in the service center may make a phone call to the portable terminal device 13.

According to the present embodiment, when the predetermined condition is satisfied, in this case, when it is detected that the user of the portable terminal device 13 has moved outside of the vehicle, the emergency notification device 11 transmits the call reception signal to the portable terminal device 13, and acquires the phone number of the portable terminal device 13 from the portable terminal device 13. Then, the emergency notification device 11 transmits the acquired phone number to the center device 12. Then, instead of the phone number of the emergency notification device 11 which is set as the destination phone number in advance, the center device 12 sets the phone number of the portable terminal device 13 received from the emergency notification device 11 as a new destination phone number.

As a result, in an emergency occurrence of the vehicle, when the user leaves the vehicle for safety reason and the user is unable to or difficult to use the emergency notification device 11, the user can receive a call from the operator of the center device 12 with the use of the portable terminal device 13.

Further, according to the present embodiment, under the condition that the user of the portable terminal device 13 has moved outside of the vehicle, the destination phone number registered in the center device 12 in advance is replaced with the phone number of the portable terminal device 13. Based on the fact that the user has moved outside of the vehicle, it can be assumed that the user has not lost consciousness and can receive a call in a state of being somewhat safe area away from the vehicle. Therefore, in such a case, the operator can preferentially make a call to the portable terminal device 13 of the user who has moved outside of the vehicle.

Further, according to the present embodiment, when it is detected that the user has moved outside of the vehicle, the emergency notification device 11 performs authentication of the portable terminal device 13. Then, the emergency notification device 11 receives the call reception signal and acquires the phone number of the portable terminal device 13 from the portable terminal device 13 which is authenticated to be valid. In other words, after confirming that the portable terminal device from which the phone number is acquired belongs to the registered user, the phone number is acquired from the portable terminal device and set as a new destination phone number. As a result, the phone number of the portable terminal device other than the portable terminal device 13 of the user who has moved outside of the vehicle can be prevented from being set as a new destination phone number.

### Second Embodiment

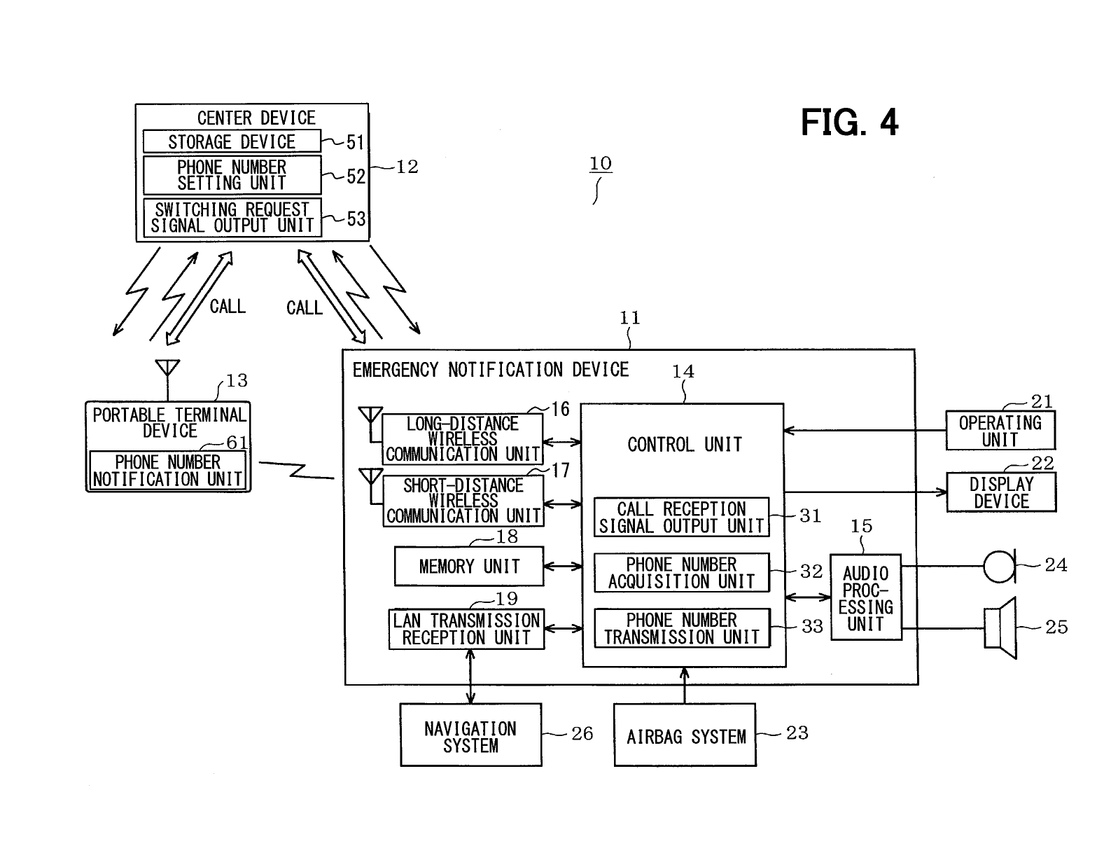

As illustrated in FIG. 4, in the present embodiment, a center device 12 virtually implements a switching request signal output unit 53 in a software manner with the execution of an emergency notification program using a CPU. In addition, the center device 12 may further include the switching request signal output unit 53 which is implemented by a hardware circuit. The switching request signal output unit 53 is an example of switching request signal output means. When an operator working in the center device 12 inputs an operation for outputting a switching request signal, the switching request signal output unit 53 outputs the switching request signal to the emergency notification device 11 that has output the emergency notification signal. The switching request signal is a signal for requesting switching of the destination phone number preliminarily registered in the center device 12.

In addition, in the present embodiment, upon receiving the switching request signal from the center device, a call reception signal output unit 31 in the emergency notification device 31 determines that a predetermined condition is satisfied and outputs a call reception signal. Further, in the present embodiment, the emergency notification device 11 does not include a detection unit 34 and an authentication unit 35.

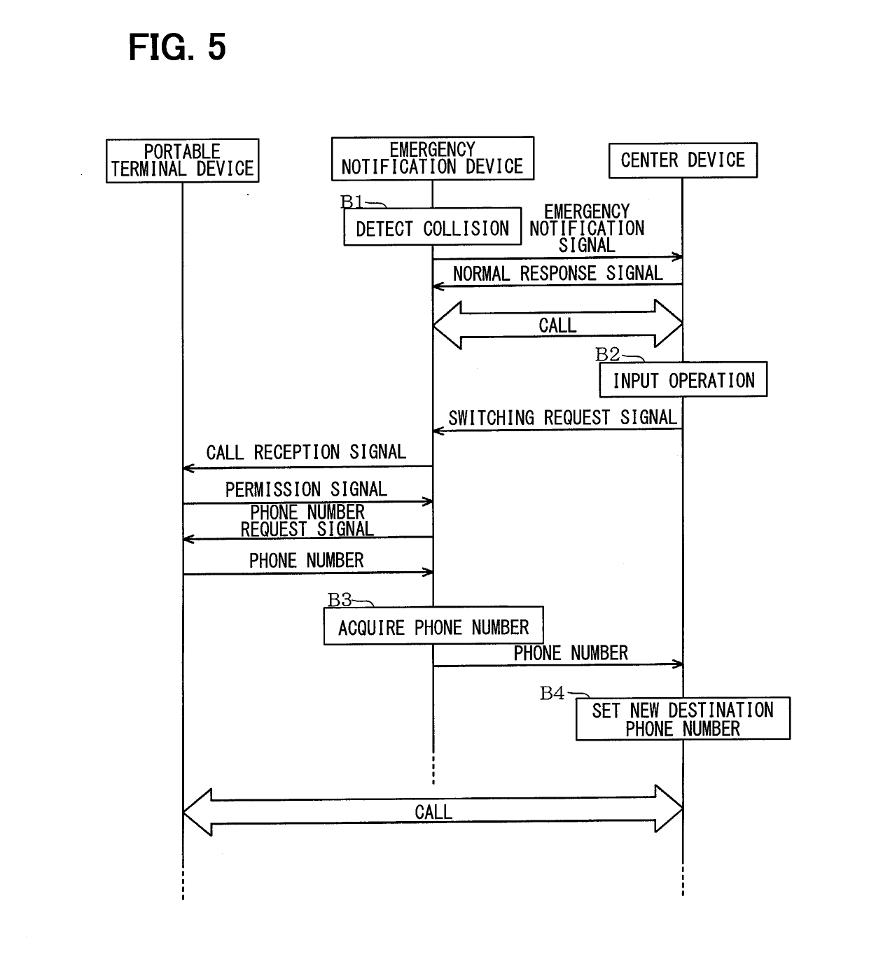

Next, an example of the emergency notification operation according to the present embodiment will be described. As illustrated in FIG. 5, when a collision detection signal is output from the emergency notification device 11 (B1), a state in which a calling communication is enabled between the emergency notification device 11 and the center device 12 through transmission and reception of various signals is established. After the calling enabled state is established, the operator on the center device 12 side inputs an operation for outputting the switching request signal to the center device 12 when there is no response from the user on the emergency notification device 11 side (B2). The center device 12 which received the operation outputs the switching request signal to the emergency notification device 11.

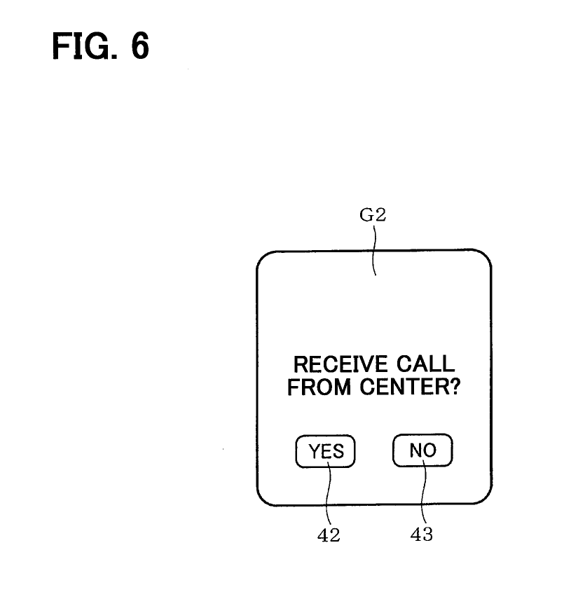

Upon receiving the switching request signal, the emergency notification device 11 outputs a call reception signal to all of the portable terminal devices 13 communicably connected to the emergency notification device 11 through the short-distance wireless line. Among the portable terminal devices 13 which have received the call reception signal, the portable terminal device 13 to which the emergency notification program is installed displays a call reception window G2 exemplified in FIG. 6 on the display unit. The call reception window G2 is provided with a YES button 42 for permitting the reception of a call and a NO button 43 for forbidding the reception of the call. When the user operates the YES button 42, the portable terminal device 13 transmits a permission signal indicating that the reception of the call is permitted to the emergency notification device 11.

Upon receiving the permission signal from the portable terminal device 13, the emergency notification device 11 outputs a phone number request signal to the portable terminal device 13. Upon receiving the phone number request signal, the portable terminal device 13 notifies the emergency notification device 11 of the phone number assigned to the portable terminal device 13. As a result, the emergency notification device 11 acquires the phone number of the portable terminal device 13 from the portable terminal device 13 which permits the reception of the call (B3). Then, the emergency notification device 11 transmits the acquired phone number to the center device 12.

Upon receiving the phone number from the emergency notification device 11, the center device 12 replaces the phone number of the emergency notification device 11 previously set as the destination phone number with the received phone number as a new destination phone number (B4). Then, the center device 12 automatically makes a call to the newly set destination phone number, and establishes a state in which a call communication is enabled between the portable terminal device 13 and the center device 12. Alternatively, the center device 12 may display a newly set destination phone number on a display unit such as a display instrument, and an operator working in the service center may make a phone call to the portable terminal device 13.

According to the present embodiment, when the predetermined condition is satisfied, in this case, upon receiving the switching request signal from the center device 12, the emergency notification device 11 outputs the call reception signal to the portable terminal device 13, and acquires the phone number of the portable terminal device 13 from the portable terminal device 13. Then, the emergency notification device 11 transmits the acquired phone number to the center device 12. Then, instead of the phone number of the emergency notification device 11 which is set as the destination phone number in advance, the center device 12 sets the phone number of the portable terminal device 13 received from the emergency notification device 11 as a new destination phone number.

With the above configuration, when call making with use of the emergency notification device 11 becomes impossible or difficult for the user due to the situation, for example, when the user loses consciousness in the event of an emergency of the vehicle, the destination phone number set in advance can be switched to the phone number of the portable terminal device existing within a range enabling short-distance wireless communication with the emergency notification device 11 based on the determination of the operator on the side of the center device 12. As a result, the operator can make a call to the portable terminal device carried by an arbitrary person present in the vicinity of the vehicle, such as a passerby, and can determine the situation through the call and give a reaction to the emergency situation.

In the present disclosure, the respective emergency notification programs to be incorporated and executed in the emergency notification device, the center device, and the portable terminal device may also be provided as an emergency notification method or an emergency notification program product stored in a computer-readable non-transitory tangible storage medium.

### Another Embodiment

The present disclosure is not limited to the embodiments described above, and can be applied to various embodiments without departing from the spirit of the present disclosure.

For example, in the second embodiment, the emergency notification device 11 may be provided with the authentication unit 35 so that authentication process is performed on the portable terminal device that acquires the phone number. Also, the first embodiment and the second embodiment may be combined together. In addition, the short-distance wireless communication unit 17 may be provided in a device separate from the emergency notification device 11. In other words, the emergency notification device 11 may be configured to realize the short-distance wireless communication function in cooperation with another device having the short-distance wireless communication unit 17.

While the disclosure has been described with reference to preferred embodiments thereof, it is to be understood that the disclosure is not limited to the preferred embodiments and constructions. The disclosure is intended to cover various modification and equivalent arrangements. In addition, while the various combinations and configurations, which are preferred, other combinations and configurations, including more, less or only a single element, are also within the spirit and scope of the disclosure.

What is claimed is:

1. An emergency notification system comprising:
an emergency notification device equipped to a vehicle;
a center device disposed at a service center and making a call with the emergency notification device through a wireless communication line; and
a portable terminal device communicably connected with the emergency notification device in a wireless manner, wherein
the emergency notification device includes:
a call reception signal output unit outputting a call reception signal to the portable terminal device when a predetermined condition is satisfied;
a phone number acquisition unit acquiring a phone number of the portable terminal device from the portable terminal device that received the call reception signal; and
a phone number transmission unit transmitting, to the center device, the phone number that is acquired, and
the center device includes a phone number setting unit that sets the phone number transmitted from the emergency notification device as a new destination phone number instead of a phone number of the emergency notification device which is preliminarily set as a destination phone number.

2. The emergency notification system according to claim 1, wherein
the emergency notification device further includes a detection unit that detects whether a user of the portable terminal device moved out of the vehicle, and
when the detection unit detects that the user moved out of the vehicle, the call reception signal output unit determines that the predetermined condition is satisfied and outputs the call reception signal.

3. The emergency notification system according to claim 2, wherein
the emergency notification device further includes an authentication unit that performs an authentication of the portable terminal device when the detection unit detects that the user moved out of the vehicle, and
the phone number acquisition unit acquires the phone number of the portable terminal device from the portable terminal device that received the call reception signal and is authenticated by the authentication unit.

4. The emergency notification system according to claim 1, wherein
the center device further includes a switching request signal output unit that outputs a switching request signal for requesting a switching of the destination phone number, and
the call reception signal output unit determines that the predetermined condition is established and outputs the call reception signal upon receiving of the switching request signal.

5. An emergency notification device equipped to a vehicle, wherein the emergency notification device constitutes an emergency notification system together with a center device and a portable terminal device, the center device is disposed at a service center and makes a call with the emergency notification device through a wireless communication line, and the portable terminal device is communicably connected with the emergency notification device in a wireless manner,
the emergency notification device comprising:
a call reception signal output unit outputting a call reception signal to the portable terminal device when a predetermined condition is satisfied;
a phone number acquisition unit acquiring a phone number of the portable terminal device from the portable terminal device that received the call reception signal; and
a phone number transmission unit transmitting, to the center device, the phone number that is acquired.

6. A center device, wherein the center device is disposed at a service center and makes a call with an emergency notification device equipped to a vehicle through a wireless communication line, the center device constitutes an emergency notification system together with the emergency notification device and a portable terminal device, and the portable terminal device is communicably connected to the emergency notification device in a wireless manner,
the center device comprising:
a phone number setting unit setting a phone number received from the emergency notification device as a new destination phone number instead of a phone number of the emergency notification device which is preliminarily set as a destination phone number.

7. A portable terminal device communicably connected to an emergency notification device equipped to a vehicle in a wireless manner, wherein the portable terminal device constituting an emergency notification system together with the emergency notification device and a center device, and the center device is disposed at a service center and makes a call with the emergency notification device through a wireless communication line,
the portable terminal device comprising:
a phone number notification unit notifying the emergency notification device of a phone number of the portable terminal device upon receiving a call reception signal from the emergency notification device.

8. An emergency notification program product installed in and executed by an emergency notification device constituting an emergency notification system, wherein the emergency notification system includes the emergency notification device equipped to a vehicle, a center device disposed at a service center and making a call with the emergency notification device through a wireless communication line, and a portable terminal device communicably connected with the emergency notification device in a wireless manner, the emergency notification program product is stored in a non-transitory tangible computer readable storage medium and comprises instructions executable by a computer,
the instructions for implementing:
outputting a call reception signal to the portable terminal device when a predetermined condition is established;
acquiring a phone number of the portable terminal device from the portable terminal device that received the call reception signal; and
transmitting, to the center device, the phone number that is acquired.

9. An emergency notification program product installed in and executed by a center device constituting an emergency notification system, wherein the emergency notification system includes an emergency notification device equipped to a vehicle, the center device disposed at a service center and making a call with the emergency notification device through a wireless communication line, and a portable terminal device communicably connected with the emergency notification device in a wireless manner, the emergency notification program product is stored in a non-transitory tangible computer readable storage medium and comprises instructions executable by a computer,
the instructions for implementing:
setting a phone number newly transmitted from the emergency notification device as a new destination phone number instead of a phone number of the emergency notification device which is preliminarily set as a destination phone number.

10. An emergency notification program product installed in and executed by a portable terminal device constituting an emergency notification system, wherein the emergency notification system includes an emergency notification device equipped to a vehicle, a center device disposed at a service center and making a call with the emergency notification device through a wireless communication line, and the portable terminal device communicably connected with the emergency notification device in a wireless manner, the emergency notification program product is stored in a non-transitory tangible computer readable storage medium and comprises instructions executable by a computer,
the instructions for implementing:
notifying the emergency notification device of a phone number of the portable terminal device upon receiving a call reception signal from the emergency notification device.
